(19) United States
(12) Patent Application Publication
(10) Pub. No.: US 2022/0128263 A1
(43) Pub. Date: Apr. 28, 2022

(54) MULTI-PORT VENTILATION

(71) Applicant: Broan-NuTone LLC, Hartford, WI (US)

(72) Inventors: Richard R. Sinur, Hartford, WI (US); Ryan A. Revers, Hartford, WI (US)

(21) Appl. No.: 17/487,403

(22) Filed: Sep. 28, 2021

Related U.S. Application Data
(60) Provisional application No. 63/106,118, filed on Oct. 27, 2020.

(51) Int. Cl. F24F 13/10; F24F 11/89; F24F 7/04

(52) U.S. Cl. CPC F24F 13/10; F24F 7/04; F24F 11/89

(57) ABSTRACT

A ventilation device having a housing defining an outlet, a first inlet configured to be in fluid communication with a first room of a building structure and a second inlet configured to be in fluid communication with a second room of a building structure. A blower is located within the housing to move air from the first and second inlet to the outlet. A first damper is located adjacent the first inlet and configured to be operable between a closed position blocking fluid communication between the blower and the first inlet and an open position allowing fluid communication between the blower and the first inlet. A second damper is located adjacent the second inlet and configured to be operable between a closed position blocking fluid communication between the blower and the second inlet and an open position allowing fluid communication between the blower and the second inlet. The first damper and the second damper are individually controllable to allow the blower to facilitate different ventilation rates through the first inlet and the second inlet.

### PRIORITY

This application claims benefit under 35 U.S.C. § 119(e) to U.S. Provisional Application Ser. No. 63/106,118, filed Oct. 27, 2020, which is expressly incorporated by reference herein and made a part hereof.

### TECHNICAL FIELD

The present disclosure relates to devices, systems, and methods for ventilation. More particularly, but not exclusively, the present disclosure relates to devices, systems, and methods for ventilation of multiple rooms.

### BRIEF DESCRIPTION OF THE DRAWINGS

FIG. 1 depicts an exemplary multi-port ventilation device situated in an exemplary building structure.

FIG. 2 depicts an exemplary multi-port ventilation device.

FIG. 3 depicts an alternate embodiment exemplary multi-port ventilation device.

### DETAILED DESCRIPTION

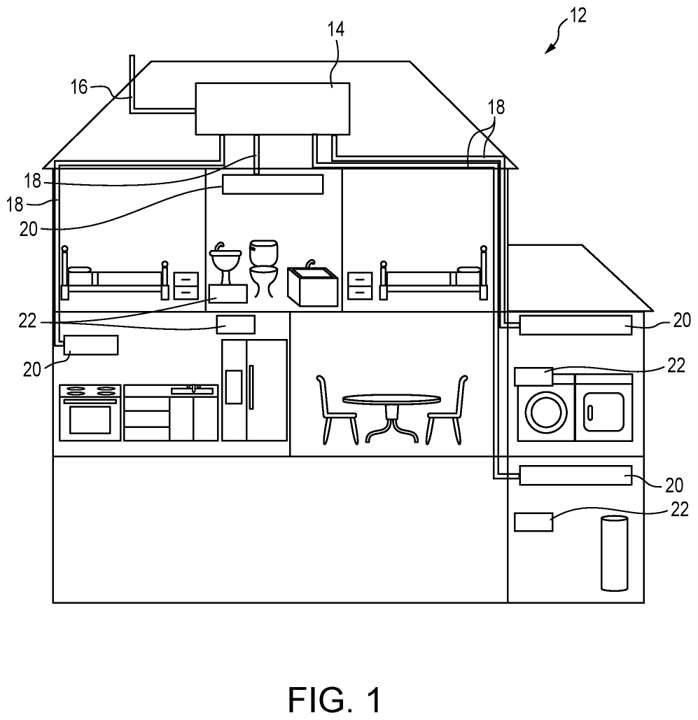

An illustrative multi-port ventilation system 12 is shown in FIG. 1, including a multi-port ventilation device 14 in fluid communication with a number of rooms to provide selective ventilation of one or more of the rooms of a building structure. Although shown in FIG. 1 as installed within a residence, the multi-port ventilation system 12 may be applied to any variety of structure having multiple enclosed or semi-enclosed spaces as rooms. While traditional ventilation of various rooms of a building can include individual ventilation fans, installed in the ceiling or wall of each space to be ventilated, the installation requirements for such traditional designs can be cumbersome and costly.

The multi-port ventilation system 12 of the present disclosure illustratively includes an exhaust line 16 providing fluid communication to expel ventilation air from the multi-port ventilation system 12 and the building structure. The exhaust line 16 is illustratively shown extending from the multi-port ventilation device 14 to a terminal exhaust end arranged outside the building for expelling ventilation air to atmosphere. The multi-port ventilation system 12 includes a number of ventilation lines 18 each extending between the multi-port ventilation device 14 and a room of the building to be ventilated to facilitate selective ventilation of each room individually.

Each ventilation line 18 illustratively includes a register 20 arranged near the terminal end of the ventilation line 18. Each register 20 provides fluid communication of the room with the respective ventilation line 18, and can provide a visual covering of the terminal end of the ventilation line 18 for aesthetic appeal and to partial obstruct access to the ventilation line 18 from the room. In some embodiments, each register 20 may include a light fixture, such as an LED light fixture for illuminating the room. In the illustrative embodiment, each ventilation line 18 is shown as an individual duct providing fluid communication of the multi-port ventilation device 14 with one individual room; however, in some embodiments, individual ventilation lines 18 may provide fluid communication of the multi-port ventilation device 14 with more than one room and/or space within a room.

As discussed in additional detail herein, the multi-port ventilation system 12 can provide customizable ventilation configuration through individualized ventilation control for each of the ventilated rooms. When a user enters a room and activates a user-activatable ventilation switch, such as a traditional manual wall switch for activating a traditional ceiling mounted ventilation fan, the multi-port ventilation device 14 can activate to provide ventilation for the specific room corresponding with the ventilation switch, with or without changing the ventilation of other rooms.

In some embodiments, various rooms may include one or more sensors 22 for detecting air conditions of rooms, such as temperature, humidity and/or air quality, to assist in automated ventilation control. Conditions detected by the sensors 22 can be communicated to a controller for governing activation or control of ventilation activities of the multi-port ventilation device 14. The controller may be located within the room, or at the multi-port ventilation device 14 or on the cloud and accessed via wi-fi and the internet.

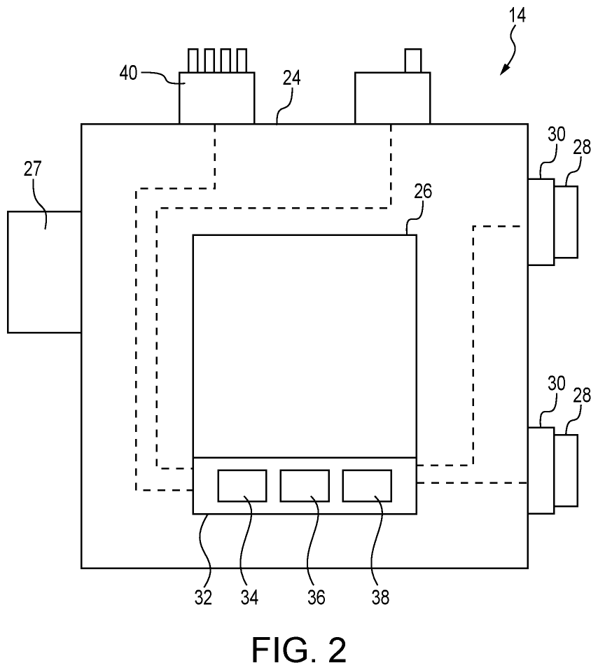

Referring now to FIG. 2, the multi-port ventilation device 14 includes a housing 24 which defines a ventilation air box. The multi-port ventilation device 14 includes a ventilation fan 26 for selectively removing ventilation air from rooms of the building. The ventilation fan 26 is illustratively embodied as a blower that is driven by permanent magnet synchronous motor, operable by a ventilation device control system 32 for variable flow rate operation according to the operations disclosed herein, for example, by variable speed and/or blade position/pitch.

The ventilation fan 26 is arranged in communication with a ventilation outlet 27 and ventilation inlets 28 of the housing 24. The ventilation outlet 27 is arranged for connection with the exhaust line 16 to provide fluid communication between the ventilation fan 26 and the exterior of the building. Each ventilation inlet 28 is arranged for connection with an end of one of the ventilation lines 18 to provide fluid communication between the ventilation fan 26 and the respective rooms. The ventilation fan 26 illustratively displaces ventilation air out through the ventilation outlet 27 and draws ventilation air in through the ventilation inlets 28, according to the governing control disclosed herein.

The multi-port ventilation device 14 includes a plurality of individually controllable ventilation dampers 30. Each individually controllable ventilation damper 30 is illustratively arranged near a respective ventilation inlet 28 between a ventilation line 18 and ventilation fan 26. Each ventilation damper 30 is individually and variably operable between a closed position blocking against flow of ventilation air through its respective ventilation inlet 28, and an open position permitting flow of ventilation air through its respective ventilation inlet 28 to regulate air flow from each room to range. Ventilation dampers 30 are illustratively embodied as butterfly dampers, but in some embodiments, may include any suitable manner of damper for assisting ventilation operations as disclosed herein. Each ventilation damper 30 is illustratively arranged in communication with the ventilation device control system 32 for governing control of the position of each ventilation damper 30.

The ventilation device control system 32 illustratively includes a processor 34 for executing instructions stored on memory 36, and communication circuitry 38 for sending/receiving communication signals according to the processor 34. The ventilation device control system 32 determines the appropriate operation of ventilation fan 26 and/or each ventilation damper 30 according to the ventilation needs of the building.

For example, if a ventilation switch is activated for only one room, e.g., a ventilation range hood of a kitchen, the ventilation device control system 32 can control the ventilation damper 30 fluidly connected by a ventilation line 18 to the range hood of the kitchen to open, while closing (or maintaining closed) ventilation dampers 30 corresponding to rooms with inactivated ventilation switches. The ventilation device control system 32 can control the ventilation fan 26 to provide the appropriate flow rate (CFM) of ventilation air according to the present state of ventilation needs, for example, 400 CFM when only the hood of the kitchen is activated. Upon additional activation of another ventilation switch of another room, e.g., a bathroom, while the hood of the kitchen remains activated for ventilation, the ventilation device control system 32 can position the corresponding ventilation damper 30 (for the bathroom) to ventilation the bathroom, and can adjust the operation of the ventilation fan 26 to provide the new appropriate flow rate (CFM) of ventilation air for the combined hood of kitchen and bathroom, for example, adding 250 CFM for a total of 650 CFM. Upon reduction in the total ventilation requirements, for example, by deactivation of ventilation for the hood of the kitchen while the bathroom remains activated for ventilation, the control system 32 can adjust the ventilation fan 26 to the new lower flow rate, e.g., 250 CFM.

The control system 32 may throttle the individual dampers 30 according to the current ventilation needs to provide appropriate ventilation to each room having activated ventilation. In some embodiments, the ventilation device control system 32 may determine operational control based at least in part on information from sensors 22 for automated control independent from (or in combination with) user-activatable ventilation switches; for example, to provide activation of ventilation for a bathroom upon detection of threshold humidity.

The multi-port ventilation device 14 can include a light control module 40 for controlling operation of light fixtures of the registers 20, for example, according to user operation of user-activatable light switches within each room. The light control module 40 can include one or more LED drivers for operation of the LED fixture of the registers 20. The multi-port ventilation device 14 can include a junction box 42 for electrical power. The junction box 42 and/or the ventilation device control system 32 can provide wireless communication capability to communicate the ventilation device 14 with a remote system, for example, a mobile device via WiFi, cellular, and/or any other suitable wireless communications means. A user may operate a mobile device, e.g., via a mobile app, to adjust the ventilation air flow rates provided by the multi-port ventilation device 14 for each individual room under given operating conditions. For example, the user may adjust predetermined flow rates, e.g., stored in the memory 36, corresponding with each room. Continuing from previous examples, the user may adjust the predetermined maximum ventilation flow rate of the range hood for the kitchen to be 500 CFM, and/or the predetermined maximum ventilation flow rate for the bathroom to be 225 CFM. Alternatively, or in addition, the user may adjust air quality thresholds to activate ventilation. The ventilation device control system 32 can receive the user's adjusted settings and determine the appropriate adjustments to operation of the ventilation fan 26 and/or individual ventilation dampers 30 accordingly.

Still referring to FIG. 2, in a refresh mode, the ventilation fan 26 can be operated to reverse ventilation flow direction to draw ambient air into the building. The ventilation device control system 32 can selective operate the ventilation fan 26 to draw ambient air through the ventilation outlet 27 from the exhaust line 16 for distribution to the building. The ventilation device control system 32 can selectively operate one or more of the ventilation dampers 30 to govern distribution of the ambient air to selected rooms of the building.

For example, the kitchen may be selected for refresh mode operation, while a bathroom is not selected. The ventilation device control system 32 selectively operates the ventilation fan 26 to draw ambient air through the ventilation outlet 27 and selectively operates the ventilation damper 30 corresponding with the kitchen to an open position appropriate for the desired flow rate of refresh ventilation flow, and selectively operates the ventilation damper 30 corresponding with the bathroom to a closed position to block against flow of refresh ventilation flow to the bathroom. The ventilation control device 32 can selectively operate the ventilation fan 265 to have speed appropriate to the refresh mode flow needs, including but without limitation, the number and/or size of rooms selected for refresh flow. In the illustrative embodiment, the refresh mode includes reversing ventilation flow direction by reversing the direction of rotation of the ventilation fan 26, however, in some embodiments, any suitable manner of reversing the direction of ventilation flow may be applied, including but without limitation, change of fan blade pitch.

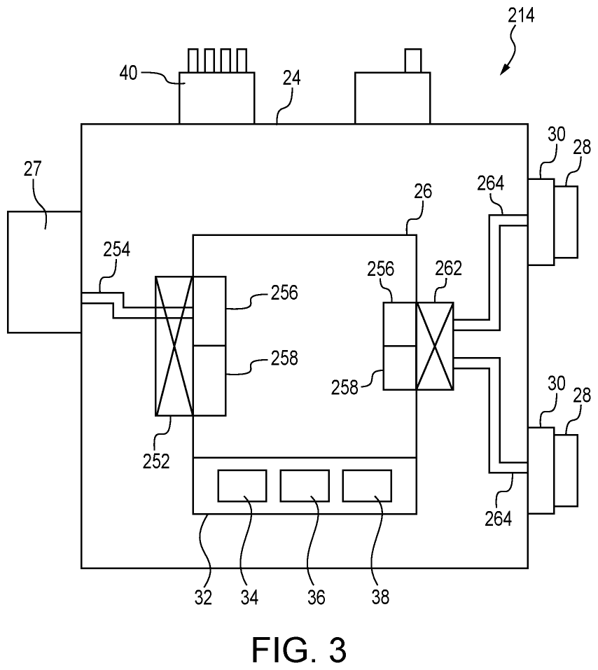

Referring now to FIG. 3, another embodiment of a ventilation device 214 as a portion of the ventilation system 12 is shown, omitting communication connections (i.e., broken lines) for descriptive ease. The ventilation device 214 is similar to the ventilation device 14 and the disclosure of ventilation device 14 applies equally to ventilation device 214, except as indicated otherwise. Unlike the ventilation system 14, the ventilation device 214 includes selective communication of the intake and/or discharge of the ventilation fan 26 with the ventilation inlets 28 and/or outlet 27.

The ventilation device 214 includes an exhaust control valve assembly 252 arranged in flow communication with the ventilation outlet 27, illustratively via flow channel 254. The exhaust control valve assembly 252 is configured for selective positioning between an exhaust position communicating a discharge 256 of the ventilation fan 26 with the ventilation outlet 27 and blocking against communication of the ventilation outlet 27 with an intake 258 of the ventilation fan 26, and a refresh position communicating the intake 258 of the ventilation fan 26 with the ventilation outlet 27 and blocking against communication of the ventilation outlet 27 with the discharge 256 of the ventilation fan 26. The exhaust control valve assembly 252 illustratively includes a single, two position valve, but in some embodiments, may include any suitable arrangement of valves and/or auxiliaries to support selective flow operation as disclosed.

The ventilation control system 32 governs selective positioning of the exhaust control valve assembly 252. In an exhaust mode, the ventilation control device 32 operates the exhaust control valve assembly 252 to have the exhaust position to provide selective ventilation to rooms as disclosed herein. In a refresh mode, the ventilation control device 32 operates the exhaust control valve assembly 252 to have the refresh position to provide selective flow of ambient air to rooms.

The ventilation device 214 includes an inlet control valve assembly 262 arranged in flow communication with the ventilation inlets 28, illustratively via flow channels 264. The inlet control valve assembly 262 is configured for selective positioning between a return position communicating the intake 258 of the ventilation fan 26 with the ventilation inlets 28 and blocking against communication of the ventilation inlets 28 with the discharge 256 of the ventilation fan 26, and a feed position communicating a discharge 256 of the ventilation fan 26 with the ventilation inlets 28 and blocking against communication of the ventilation inlets 28 with an intake 258 of the ventilation fan 26.

In the refresh mode of ventilation device 214, the inlet control valve assembly 262 is arranged in the feed position such that the discharge 256 of the ventilation fan 26 is in communication with the ventilation inlets 28, although the ventilation dampers 30 are operable between open and closed positions, to regulate the flow for each individual ventilation inlet. Accordingly, in the refresh mode of ventilation device 214, the direction of rotation of the ventilation fan 26 does not change relative to the exhaust mode, and rather the connection of the intake and/or discharge of the ventilation fan 26 is selectively changed according to the position of the exhaust control valve assembly 252 and the inlet control valve assembly 262. The inlet control valve assembly 262 illustratively includes a single, two position multiport valve, but in some embodiments, may include any suitable arrangement of valves and/or auxiliaries to support selective flow operation as disclosed, for example, but without limitation, separate valves for the discharge 256 and intake 258.

In another configuration of the ventilation device 214, the exhaust control valve assembly 252 can include individual control valves for each ventilation inlet 28, with each individual valve being independently operable between feed and return positions according to the ventilation device control system 32. In such configurations in which the exhaust control valve assembly 252 includes individual control valves for each ventilation inlet 28, recirculation can be provided to recirculate flow from the building to rooms. In such arrangements, any individual control valve of the inlet control valve assembly 262 may be positioned in the return position while one or more of the other individual control valves of the inlet control valve assembly 262 are positioned in the feed position, to draw at least a portion of flow from the room corresponding with the individual control valve in the return position (with appropriate positioning of the corresponding ventilation damper 30). In such configurations, at least a portion of flow can be delivered to the rooms corresponding with the individual control valves in the feed position (with appropriate positioning of the corresponding ventilation damper 30), providing at least partial recirculation. Accordingly, in the refresh mode or the exhaust mode, individual rooms can be selectively operated for delivering or receiving flow.

In such configurations, the exhaust control valve assembly 252 is additionally operable between a closed position and the exhaust and refresh positions such that incremental positions may allow partial flow. In the closed position, exhaust control valve assembly 252 blocks against flow between the ventilation fan 26 and the ventilation outlet 27. The exhaust control valve assembly 252 can be operated according to the ventilation control device 32 in the closed position to block flow communication between the ventilation fan 26 and the ventilation outlet 27 (or to allow partial flow between either the ventilation outlet 27 and the discharge 256 or intake 258 of the ventilation fan 26). In such instances, the inlet control valve assembly 262 can be operated, according to the ventilation control system 32, to arrange some of the individual control valves for flow communication with the discharge 256 of the ventilation fan 26 and to arrange some of the individual control valves for flow communication with the intake 258 of the ventilation fan 26 (and with appropriate flow balancing by ventilation dampers 30). Accordingly, flow can be recirculated between rooms of the building, with or without drawing or exhausting a portion of flow via the exhaust line 16.

Implementation of devices, systems, and/or methods within the present disclosure can provide improved multi-port ventilation. Within the present disclosure, installation of individual ventilation fans with each room for ventilation can be eliminated or reduced, reducing overall installation time, effort, and/or expense for ventilation. Adjustment of individual room ventilation condition, such as CFM adjustment, can be implemented, including by centralized and/or mobile control in some embodiments. Noise attributable to individual ventilation fans can be reduced and/or managed by relocation of the principal blower to desirable space, such as the attic. Penetrations into individual rooms may be reduced in size and/or conspicuousness by eliminating individual ventilation fans in each room.

Components and features described above can be combined in various ways, to provide other non-illustrated embodiments within the scope of the disclosure. The disclosure is not limited in application to the details of construction and/or parts illustrated in the drawings and described hereinabove, but is capable of other embodiments and/or practice in various ways. Phraseology used herein is for the purpose of description and not limitation. Although described in the foregoing by way of illustrative embodiments thereof, disclosed embodiments can be modified at will, without departing from the spirit, scope, and nature of the subject disclosed.

1. A ventilation device comprising:
a housing defining an outlet, a first inlet configured to be in fluid communication with a first room of a building structure and a second inlet configured to be in fluid communication with a second room of a building structure;
a blower located within the housing and configured to move air from the first and second inlets to the outlet;
a first damper located adjacent the first inlet and configured to be operable between a closed position blocking fluid communication between the blower and the first inlet and an open position allowing fluid communication between the blower and the first inlet;
a second damper located adjacent the second inlet and configured to be operable between a closed position blocking fluid communication between the blower and the second inlet and an open position allowing fluid communication between the blower and the second inlet;
wherein, the first damper and the second damper are individually controllable to allow the blower to facilitate different ventilation rates through the first inlet and the second inlet.

2. The ventilation device of claim 1, further comprising a controller for controlling the first damper and or the second damper.

3. The ventilation device of claim 1, further comprising a first ventilation line extending from the first inlet to a first register and a second ventilation line extending from the second inlet to a second register.

4. The ventilation device of claim 2, further comprising a sensor configured to be exposed to air in the first room and wherein the controller controls the first damper based on information detected by the sensor.

5. The ventilation device of claim 4, wherein the sensor detects one or more of air quality and or humidity.

6. The ventilation device of claim 1, wherein the first damper is controllable by a manually operable switch configured to be located in the first room.

7. The ventilation device of claim 6, further comprising a sensor configured to be exposed to air in the second room and wherein the second damper is controllable based on information detected by the sensor.

8. The ventilation device of claim 1, wherein the blower is a variable speed blower.

9. The ventilation device of claim 1, further comprising an outlet valve assembly operable between a first position providing flow communication between a discharge of the blower and the outlet, and a second position providing flow communication between an intake of the blower and the outlet.

10. The ventilation device of claim 9, in the first position, the outlet valve assembly blocks against flow communication between the intake of the blower and the outlet.

11. The ventilation device of claim 9, in the second position, the outlet valve assembly blocks against flow communication between the discharge of the blower and the outlet.

12. The ventilation device of claim 9, wherein the outlet valve assembly is operable between a closed position and at least one of the first and second position, wherein in the closed position the outlet valve assembly blocks against flow communication between the outlet and the blower.

13. The ventilation device of claim 1, further comprising an inlet valve assembly operable between a feed position providing flow communication between a discharge of the blower and at least one of the first and second inlets, and a return position providing flow communication between an intake of the blower and the at least one of the first and second inlets.

14. The ventilation device of claim 13, in the feed position, the inlet valve assembly blocks against flow communication between the intake of the blower and the at least one of the first and second inlets.

15. The ventilation device of claim 9, in the return position, the inlet valve assembly blocks against flow communication between the discharge of the blower and the at least one of the first and second inlets.

16. The ventilation device of claim 1, further comprising an inlet valve assembly operable for at least partial recirculation to simultaneously provide flow communication between a discharge of the blower and one of the first and second inlets and to provide flow communication between an intake of the blower and the other one of the first and second inlets.

17. A ventilation device comprising:
a housing defining an outlet, a first inlet configured to be in fluid communication with a first room of a building structure and a second inlet configured to be in fluid communication with a second room of a building structure;
a blower located within the housing and configured to move air between the outlet and at least one of the first and second inlets;
a first damper located adjacent the first inlet and configured to be operable between a closed position blocking fluid communication between the blower and the first inlet and an open position allowing fluid communication between the blower and the first inlet;
a second damper located adjacent the second inlet and configured to be operable between a closed position blocking fluid communication between the blower and the second inlet and an open position allowing fluid communication between the blower and the second inlet;
wherein the first damper is variably operable between the closed position and the open position to facilitate different ventilation rates through the first inlet.

18. The ventilation device of claim 17, wherein the second damper is variably operable between the closed position and the open position to facilitate different ventilation rates through the second inlet.

19. A ventilation device for ventilating a building structure comprising a first room and a second room, the ventilation device comprising:
a housing defining an outlet, a first inlet configured to be in fluid communication with the first room and a second inlet configured to be in fluid communication with the second room;
a blower located within the housing and configured to move air from the first inlet to the outlet and from the second inlet to the outlet;
a first damper located adjacent the first inlet and configured to be operable between a closed position blocking fluid communication between the blower and the first inlet and an open position allowing fluid communication between the blower and the first inlet;
a second damper located adjacent the second inlet and configured to be operable between a closed position blocking fluid communication between the blower and the second inlet and an open position allowing fluid communication between the blower and the second inlet;
wherein the first damper is variably operable between the closed position and the open position to facilitate different ventilation rates through the first inlet.

20. The ventilation device of claim 19, wherein the second damper variably operable between the closed position and the open position to facilitate different ventilation rates through the second inlet.
